(19) United States
(12) Patent Application Publication
(10) Pub. No.: US 2005/0011939 A1
(43) Pub. Date: Jan. 20, 2005

(54) Pizza box

(76) Inventors: Evangelos Angelopoulos, Tarzana, CA (US); Dolores Moschetta, Tarzana, CA (US)

Correspondence Address: ROBERT M. SPERRY, ESQ., 23390 OSTRONIC DRIVE, WOODLAND HILLS, CA, 91367, US

(21) Appl. No.: 10/889,835

(22) Filed: Jul. 13, 2004

Related U.S. Application Data
(60) Provisional application No. 60/487,171, filed on Jul. 14, 2003.
(60) Provisional application No. 60/539,943, filed on Jan. 29, 2004.

(51) Int. Cl. B26D 5/42; B65D 43/08

(52) U.S. Cl. 229/109; 229/110; 229/125.19; 229/141; 229/198.2; 229/906

(57) ABSTRACT

An improved pizza delivery box having resilient corners which tend to urge the tongue and slot into locking relation to prevent the corners from opening and thereby preventing the pizza from sliding out of the box.

### RELATED CASES

This invention is described in my copending Provisional Application, Ser. No. 60,487,171, filed Jul. 14, 2003, and now ______. Ser. No. 60,539,943 filed Jan. 29, 2004

### FIELD OF INVENTION

This invention relates to containers and is particularly directed to improve boxes and trays for delivery of pizza and the like.

### PRIOR ART

Pizzas have long been popular snack foods and are usually made in restaurants or pizzerias which have no dining area but focus on take-out and home delivery. In order to transport the pizzas, it is necessary to provide a carrying container or box and numerous such boxes have been proposed heartofore. However, many of the prior art pizza delivery boxes have no vent holes. Consequently, the air with in the box is heated by the pizza and moisture with in the aid condenses, causing the pizza to become soggy. Other prior art pizza delivery boxes provide large vent holes, which allow the heat form the pizza to escape, with the result that the pizza is cold on delivery. Also, a major problem with the prior art pizza delivery boxes has been that they require assembly prior to insertion of the pizza into the box. Consequently, much labor is expended pre-assembling the boxes in considerable space is required to store the assembled boxes waiting for the pizzas to be ordered and cooked. Furthermore, many of the prior art pizza delivery boxes have been difficult or complicated to assemble, which adds considerably to the labor cost. It has been found that over ⅔rds of the labor expenses for pizzerias relates to assembly of the pizza delivery boxes. Another disadvantage of the prior art pizza delivery boxes is that the design and construction utilizes a large amount of paper material to be functional resulting in a costly pizza delivery box to manufacture. Another disadvantage of the prior art pizza delivery boxes has been that most pizza orders involve a plurality of pizzas. With the competition what it is today among the pizza stores many pizzerias have offered a plurality of pizzas at a special price savings, yet each pizza must have its own box to be transported. Consequently, a plurality of pizza delivery boxes must be stacked for carrying by the delivery man. The many turns and stops during the transport causes the shifting and sliding of the pizza delivery boxes, resulting in the pizza toppings sticking to the sides of the box, and slice separation causing the cheese to stick to the bottom of the box. The shifting also causes difficulty in keeping track of which boxes relate to which order. Thus, frequent misdelivery occurs, with resultant loss of profit and good will. Another major disadvantage of the prior art pizza delivery boxes arises from the fact that most pizza delivery boxes are formed of corrugated cardboard or particle board to minimize cost. Most of these boxes are assembled with tongue in groove connections to from the corners of the box with no interlocks for multiple stacking or to interlock the lid to the front wall panel for secure lid closing. However, due to the heat and humidity which is released by the pizza when it is placed in the box, these connections tend to become weak and flexible and often disconnect, causing the corner, and the lid of the box to open and allowing the pizza to slide out of the box. This causes the pizza to become contaminated and often causes a mess of floors, furniture and the like. Thus, none of the prior art pizza deliver boxes have been entirely satisfactory.

### BRIEF SUMMARY AND OBJECTS OF INVENTION

These disadvantages of the prior art are overcome with the present invention, improved pizza delivery boxes and trays are provided which have structural design which uses less paper material, are simple and inexpensive to manufacture, produce and assemble, yet do not require assembly prior to use. Allows pizza to be cut on an unfolded box or tray prior to assembly and which can be interlocked in a multiple stacked relation using trays and lid setup or a box with attached lid and trays combination so that the box and trays related to a given order will be connected, making it easy to ensure proper deliver and significantly reducing the manufacturing, labor and storage expenses of the pizza delivery box and trays which will not open at the corner, or the lid to allow the pizza to slide out of the box or trays.

These advantages of the present invention are preferably attained by providing improved pizza delivery boxes and trays having resilient corners which tend to urge the tabs and slots into locking relation to prevent the corners from opening and a tongue which penetrates slits slot secures the lid to the box or tray thereby preventing the pizza from sliding out of the box or tray.

Accordingly, it is an object of the present invention to provide an improved delivery box and tray for pizza and the like.

Another object of the present invention is to provide improved pizza delivery boxes and trays with structural design which will lower the cost to manufacture by the use of less paper material, yet has the ability to maintain the rigidity, strength and is functional. Thus, the structural design of the present invention is economical to manufacture and ecological to the environment.

Another object of the present invention is to provide an improved pizza delivery box and tray which is simple and inexpensive to produce and assemble.

An additional object of the present invention is to provide an improved pizza delivery tray and box which is simple and inexpensive to produce, yet does not require assembly prior to use.

A further object of the present invention is to provide an improved pizza delivery box and tray which is simple and inexpensive to produce, yet does not require assembly prior to use and can be interlocked in a stacked relation so that the box and trays related to a given order will be connected, making it easy to insure proper deliver and significantly reducing the manufacturing, labor and storage expenses of the pizza delivery boxes and trays.

Another object of the present invention is to provide an improved pizza delivery boxes and trays which will not open at the corners or the lid to allow the pizza top slide out of the box.

A specific object of the present invention is to provide improved pizza delivery boxes an trays having resilient corners which tend to urge the tabs and slots into locking relation to prevent the corners from opening and a tongue which penetrates slits slots that secures the lid to the boxes or trays, thereby preventing the pizza from sliding out of the box or tray.

These and other objects and features of the present invention will be apparent from the following detailed description, taken with reference to the figures of the accompanying drawing.

### BRIEF DESCRIPTION OF THE DRAWING

FIG. 1 is a plan view of an unfolded pizza delivery tray embodying the present invention;

FIG. 2 is a plan view of a lid for the pizza delivery tray of FIG. 1;

FIG. 3 is a plan view of an unfolded alternative form of the pizza delivery box of FIG. 1 having an attached lid;

FIG. 4 is an enlarged perspective view illustrating an assembled front corner section of the double fold tooth tab connection of FIG. 1 front wall sections and FIG. 3 front wall sections;

FIG. 5 is enlarged perspective view illustrating an unassembled corner section of the double fold tooth tab connection of FIG. 1 the front wall sections and FIG. 3 the front wall sections;

FIG. 6 is a plan view of a second unfolded pizza delivery tray embodying the present invention;

FIG. 7 is a plan view of a lid for the pizza delivery tray of FIG. 6;

FIG. 8 is a plan view of an unfolded alternative form of the pizza delivery tray of FIG. 6 having an attached lid;

FIG. 9 is an enlarged perspective view illustrating an assembled corner section of the double hook corner tab connection of FIG. 1 back corner sections, FIG. 6 front and back corner sections, FIG. 8 front corner sections, FIG. 11 back corner sections.

FIG. 10 is an enlarged perspective view illustrating an unassembled corner section of the double hook corner tab of FIG. 1 back corner sections, FIG. 6 front and back corner sections, FIG. 8 front corner sections, FIG. 11 back corner sections;

FIG. 11 is a plan view of a third unfolded pizza deliver tray embodying the present invention;

FIG. 12 is plan view of a lid for the pizza delivery tray of FIG. 11;

FIG. 13 is a plan view of an unfolded alternative form of the pizza delivery tray of FIG. 11 having an attached lid;

FIG. 14 is an enlarged perspective view illustrating an assembled corner section of the single hook tab connection of FIG. 11 front and back corner sections, FIG. 13 front corner sections, FIG. 16 and FIG. 18 front and back corner sections;

FIG. 15 is an enlarged perspective view illustrating an unassembled corner section of the single hook tab connection of FIG. 11 front and back corner sections, FIG. 13 front corner sections, FIG. 16 and FIG. 18 front and back corner sections;

FIG. 16 is a plan view of a forth unfolded pizza delivery tray embodying the present invention.

FIG. 17 is a plan view of a lid for the pizza delivery tray of FIG. 16;

FIG. 18 is a plan view of an unfolded alternative form of the pizza delivery tray of FIG. 16 having an attached lid.

### DETAILED DESCRIPTION OF THE INVENTION

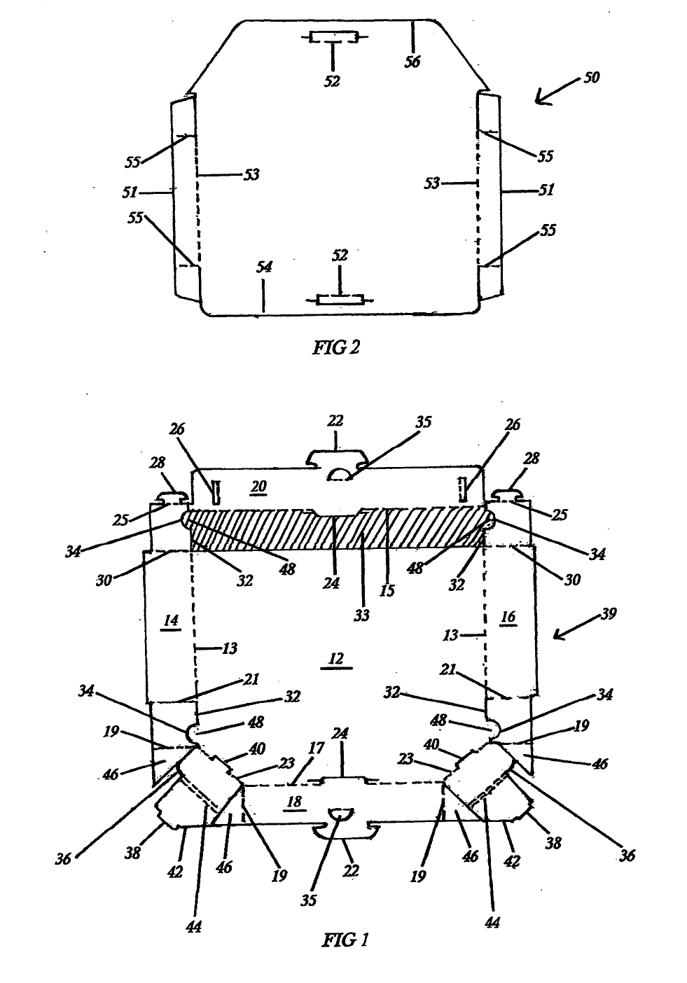

In that form of the present invention chosen for purposes of illustration in FIG. 1, a pizza delivery tray is shown, indicated generally at 39, having a floor 12 with side walls 14 and 16, a back wall 20 and a front wall 18. The front wall 18 and back wall 20 each carry vertical interlocking tongues 22 and tabs 24. When the front wall 18 and back wall 20 are folded upwardly along crease lines 15 and 17 vertical interlocking tongues 22 will project upwardly to mate with slits slots in superjacent box or tray while tabs 24 will form slits slots for receiving the vertical interlocking tongues of subjacent tray. This enables a plurality of trays and a box to be stacked together in an interlocked relation so that all the pizzas of a given order will be connected together. Back wall 20 also is formed with slots 26 which serve to receive the double hook tabs 28 carried by side walls 14 and 16, when sidewalls 14 and 16 are folded upward along crease lines 13. It will be noted that the slots 26 are spaced inwardly from the respective ends of the back wall 20 and side walls 14 and 16 are provided with crease lines 30 spaced inwardly from the double hook tabs 28. Also, the side walls 14 and 16 are each provided with cuts 32 extending inwardly form the double hook tabs 28 and having arcuate portions 34. When the side walls 14 and 16 are folded upward and the double hook tabs 28 are folded slightly along crease lines 25 and are inserted in slots 26 of the back wall 20, the double hook tabs 28 will extend at an angle to the corner of the box and the arcuate portions 34 will serve to provide as vents, poke-in tabs 35 on front wall 18 and back wall 20 also allow humidity to escape and, hence prevent a pizza contained in the tray 39 from becoming soggy. Furthermore the cuts 32 cause the shaded portion 33 of the floor 12 adjacent the back wall 20 to function as a resilient lever to urge the back wall 20 downwardly and, thereby, to retain the double hook tabs 28 in locking reflation with the slots 26. With conventional pizza delivery boxes, when a pizza is placed on the floor 12 of the tray 39, the heat and moisture escaping from the pizza tend to weaken the natural resilience of the box material, with the result the conventional tongue in groove connections tend to become disconnected allowing the corners of the box to open and enabling the pizza to slide out of the box causing loss of the pizza and a sticky mess on whatever the pizza lands. However, with the lever action provided by cuts 32 urges the double hook tabs 28-and-slots 26 connections of the present invention into locking relation, hence, such disconnecting is prevented and the pizza is securely retained within the tray 39.

At the front corners the tray 39, corner members 36 are provided extending diagonally from the front wall 18 to the respective side walls 14 and 16. The corner members 36 each carry teeth 38 which project upwardly when the corner members 36 are folded upward and have tabs 40 which form slots, when the corner members 36 are folded upward along crease lines 23 to receive the teeth 38 when the upper portions 42 of the teeth 38 are folded downwards along crease lines 44. Side walls 14 and 16 and front wall 18 carry triangle tabs 46 which are folded inward along crease lines 19 when the side walls 14 and 16 and front wall 18 are folded upward. This causes the end triangle tabs 46 to be inserted between the upper and lower portions of the corner members 36 when the teeth 38 of the corner members 36 are inserted in the slots formed by the tabs 40. This forms a secure lock for the corner members 36. Also, cuts 32 having arcuate portions 34 are provided on the side walls 14 and 16 adjacent the corner members 36. When the side walls 14 and 16 are folded upward, the arcuate portions 34 leave horizontally along crease lines 21 projecting tabs 48 which serve to support the tray 39 on the walls 14,16,18, and 20 of a subjacent tray when trays are stacked. Also, because the slots 26 in the back wall 20 are spaced inwardly from the adjacent ends of the back wall 20, areas are provided adjacent the tabs 48 at the back corners of the tray 39 which provide additional support when the trays are stacked.

FIG. 2 shows a lid, indicated generally at 50 for use with the tray 39 of FIG. 1. As shown, the lid 50 has flaps 51 which are folded along creased lines 53 and 55. Flaps are inserted into tray 39, slits slots 52 adjacent the front edge 56 and rear edge 54 which serve to receive vertical interlocking tongues 22 of the tray 39 to releasably interlock and secure the lid 50 to the tray 39. If a plurality of trays 39 are stacked, the lid 50 need only be provided for the upper most tray 39 since the floors 12 of the other trays of the stack will serve as lids for the subjacent trays 39.

In use, a plurality of unfolded trays 39 are provided and may be stacked in any convenient location in the pizza kitchen. When a pizza is made, one of the trays 39 can be removed from the stack and placed on a cutting table. The pizza may then be placed on the unfolded tray 39 for cutting. After the pizza has been cut, the pizza maker simply folds the walls 14,16,18, and 20 upward inserts the double hooked tabs 28 through slots 26 and folds the upper portions 42 of corner members 36 down ward to insert teeth 38 into the slots formed by tabs 40. A lid 50 may then be attached to vertical interlocking tongues 22 of the tray 39 and the pizza is ready for delivery in a tray and lid setup. If several pizzas are included in a single order, the pizza maker assembles the first tray 39, as described above. However, instead of applying the lid 50, the pizza maker sets the completed tray 39 aside and places a second tray 39 on the cutting table to receive the second pizza of the order. He then cuts the pizza and folds the second tray 39 as described for the first and places the second tray 39 on top of the first, so that the vertical interlocking tongues 22 of the first tray 39 are inserted into slots formed by tabs 24 of the second tray 39. This securely interlocks the two trays together. If additional pizzas are included in the order, these steps are repeated until all of the pizzas of the order have been cut and their trays folded and stacked. The pizza maker then places a lid 50 on the upper most tray 39 and the order is ready for delivery as a unit. If other orders are to be delivered at the same time all of the pizzas for each order will be interlocked, so that the delivery man can easily carry several orders without fear of dropping any of the pizzas and without getting the pizzas of one order confused with those of another order. Thus, the time and labor required for assembling and boxing pizzas is greatly reduced. This results in considerable savings for the pizza maker, while providing better quality service for the customer.

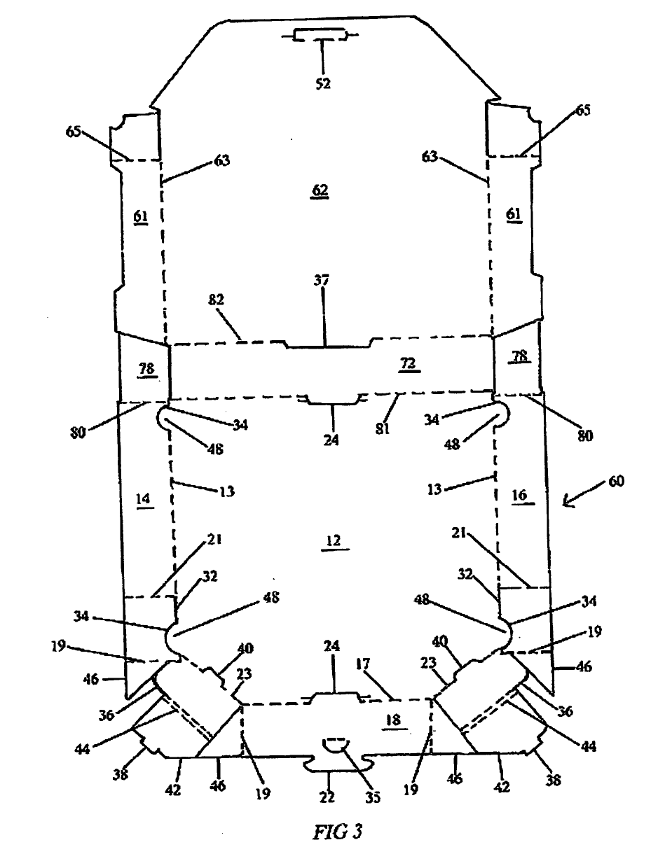

FIG. 3 shows an alternative form of the pizza delivery box of FIG. 1, indicated generally at 60 having an attached lid 62. As shown, the box 60 has a floor 12, a front wall 18, side walls 14 and 16 and a rear wall 72. The front corners of the box 60 are provided with corner members, similar to the front corner members 36 of the pizza tray 39 of FIG. 1, and similar numbers have been used to identify the respective parts thereof. Front wall 18 carries vertical interlocking tongue 22 and tab 24 corresponding the vertical interlocking tongues 22 and tabs 24 of FIG. 1. Side walls 14 and 16 have flaps 78 projecting from their rear ends, which fold inwardly, on creased lines 80. When the rear wall 72 is folded upward flaps 78 are inserted within the rear wall 72 to form the rear corners of the box 60. The lid 62 is attached to the rear wall 72 and, when the box 60 is assembled side flaps 61 of lid 62 are folded inward along crease lines 63 and 65. The lid 62 is folded along crease lines 82 to overlie the floor 12 tab 37 is formed for venting. The lid 62 is formed with slits slot 52 which receives vertical interlocking tongue 22 of the front wall 18 to close box 60. All forms of pizza delivery boxes may be used for single pizza orders however, the boxes may be used as the superjacent lid of the subjacent stacked trays the choice remains solely up to the pizza proprietor.

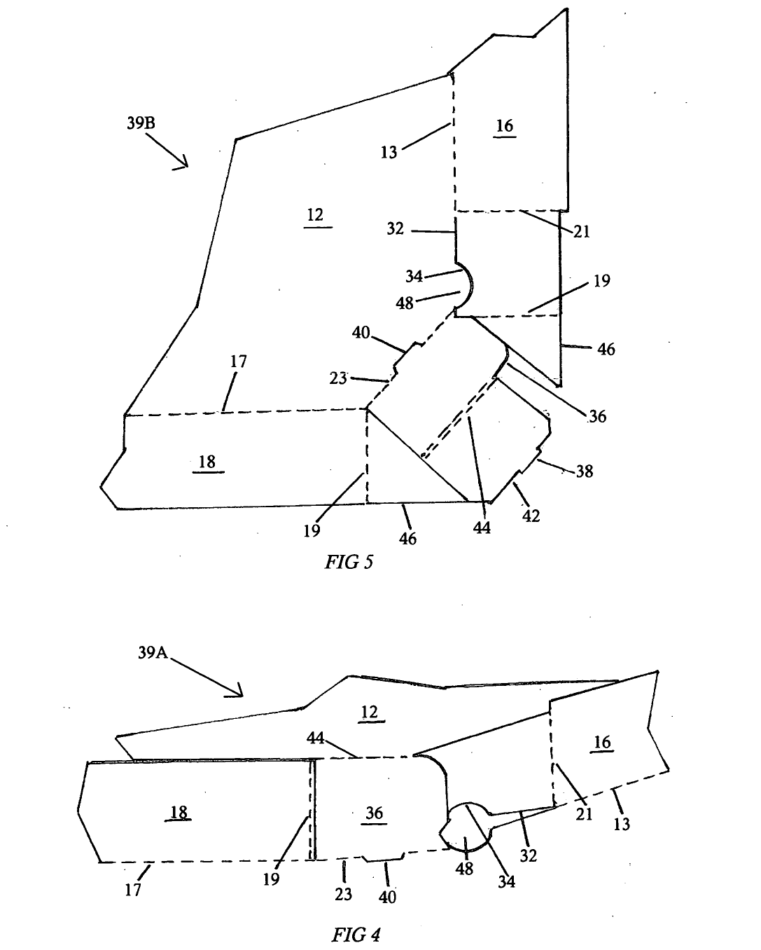

FIG. 4 shows an enlarged perspective view generally at 39A, illustrating an assembled front corner section of the double fold tooth tab connection of FIG. 1 the front wall corner sections and FIG. 3 the front wall corner sections. Component numbers and method of assembly is described in detail in FIG. 1.

FIG. 5 shows an enlarged perspective view generally at 39B, illustrating an unassembled front corner section of the double fold tooth tab connection of FIG. 1 the front wall corner sections and FIG. 3 the front wall corner sections. Component numbers and method of assembling is described in detail in FIG. 1

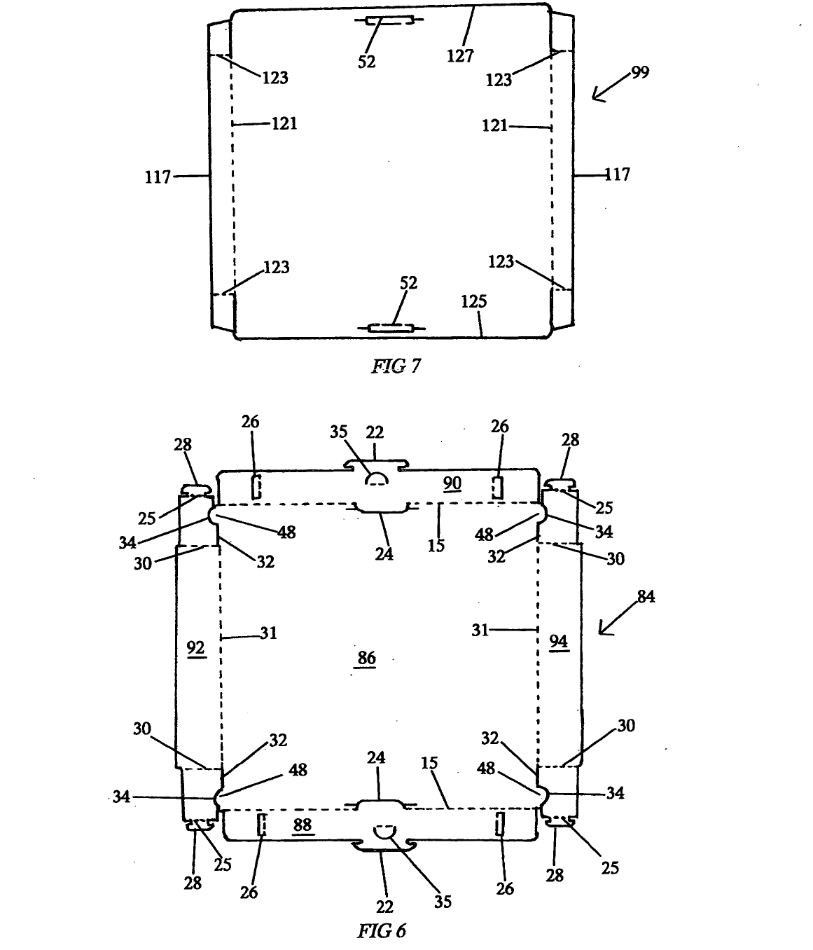

FIG. 6 shows a second alternative form of the pizza delivery tray 39 of FIG. 1, indicated generally at 84, and having a floor 86, a front wall 88, a rear wall 90 and side walls 92 and 94 along crease lines 31. In this form of the present invention, the front wall 88 and rear wall 90 along crease lines 15 are similar to back wall 20 of the pizza delivery tray 39 of FIG. 1. Thus, the front wall 88 and rear wall 90 carry vertical interlocking tongues 22, which project upwardly for insertion into slits slots of superjacent box or trays when the walls 88 and 90 are folded upward and have tabs 24, which form slits slots when the walls 88 and 90 are folded upward to receive the vertical interlocking tongues 22 of the subjacent tray 84. The side walls 92 and 94 carry double hook tabs 28, similar to the double hook tabs 28 of FIG. 1, for insertion into slots 26 in the front wall 88 and rear wall 90. As in FIG. 1, cuts 32 with arcuate portions 34 are provided adjacent each of the double hooked tabs 28 to provide a spring-like action to ensure retention of the double hooked tabs 28 in the slots 26 and to provide tabs 48 for supporting the tray 84 on subjacent tray 84 when two or more trays 84 are stacked together.

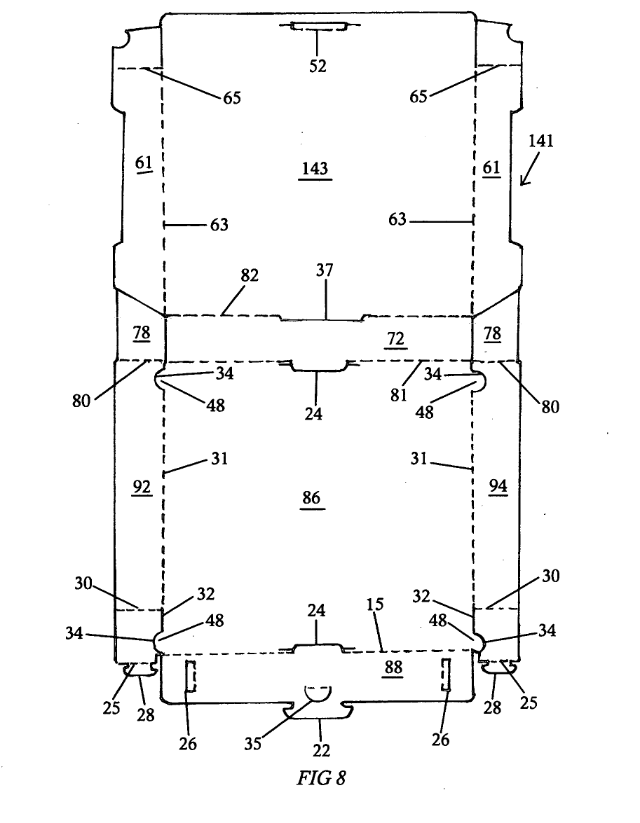

FIG. 7 shows a lid, indicated generally at 99 for use with the tray 84 of FIG. 6. As shown the lid 99 has flaps 117 which are folded along creased lines 121 and 123. Flaps 117 are inserted into tray 84, slits slots 52 adjacent the front edge 125 and rear edge 127 which serve to receive vertical interlocking tongues 22 of the tray 84 to releasably interlock and secure the lid 99 to the tray 84. If a plurality of trays 84 are stacked the lid 99 need only be provided for the uppermost trays 84 since the floors 86 of the other trays of the stack will serve as lids for the subjacent trays 84.

FIG. 8 shows an alternative form of the pizza delivery tray of FIG. 6, indicated generally at 141 having an attached lid 143. As shown the box 141 has a floor 86 a front wall 88 side walls 92 and 94 and a rear wall 72. The front corners of box 141 are provided with corner members similar to the back corner members of the pizza delivery trays 39 of FIG. 1 and the front and back corner members of the pizza delivery tray 84 of FIG. 6 and similar numbers have been used to identify the respective parts thereof. Front wall 88 carries vertical interlocking tongue 22 and tab 24 corresponding the vertical interlocking tongues 22 and tabs 24 of FIG. 1, FIG. 3 and FIG. 6. Side walls 92 and 94 have flaps 78 projecting from their rear ends, which folds inwardly on creased lines 80. When the rear walls 72 is folded upward along crease lines 81 flaps 78 are inserted within the rear wall 72 to form the rear corners of the box 141. The lid 143 is attached to the rear walls 72 and when the box 141 is assembled side flaps 61 of lid 143 are folded inward along crease lines 63 and 65. The lid 143 is folded along crease line 82 to overlie the floor 86. The lid 143 is formed with slits slot 52 which receives vertical interlocking tongue 22 of the front wall 88 to releasably interlock and secure the lid 143 to the box 141.

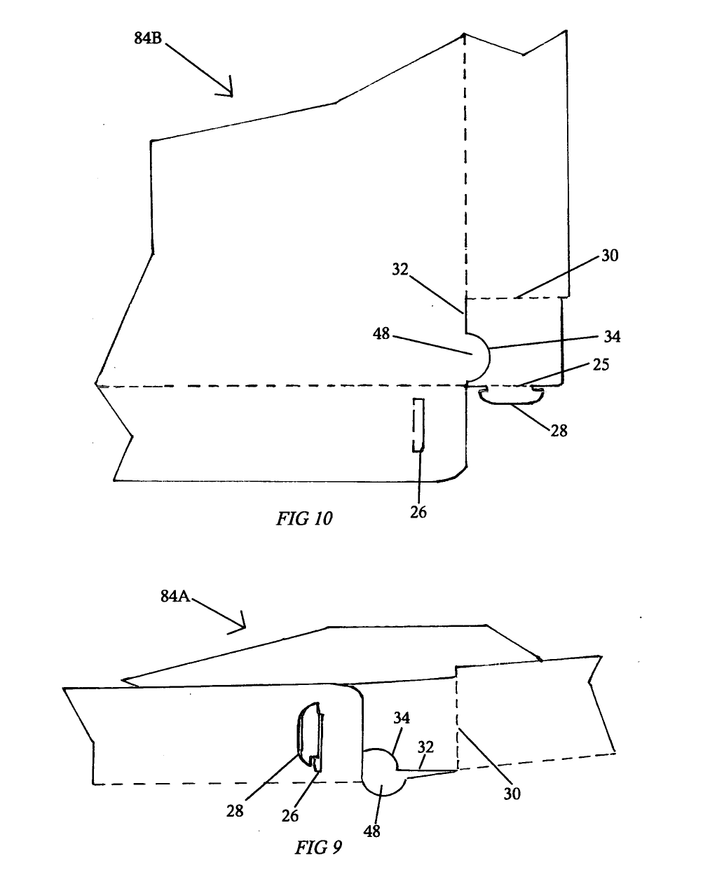

FIG. 9 shows an enlarged perspective view generally at 84A, illustrating an assembled front corner section of the double hooked tab connection of FIG. 1 back corner sections, FIG. 6 front and back corner sections, FIG. 8 front corner sections, FIG. 11 back corner sections. Component numbers and method of assembly is described in FIG. 1.

FIG. 10 is an enlarged perspective view generally at 84B, illustrating an unassembled corner section of the double hook tab of FIG. 1 back corner sections, FIG. 6 front and back corner sections, FIG. 8 front corner sections, FIG. 11 back corner sections. Component numbers and method of assembly is described in detail in FIG. 1.

FIG. 11 shows a third alternative form of the pizza delivery tray 39 indicated generally at 96, having a floor 98, front wall 100 along crease line 113 rear wall 102 along crease line 115 and side walls 104 and 106. The side walls 104 and 106 are connected to the rear wall 102 by double hook tabs 28 and slots 26 connections, similar to those connecting the back and side walls of FIG. 1 and similar numbers have been used to identify the respective components thereof. Also, the front wall 100 and the rear wall 102 carry vertical interlocking tongues 22 and tabs 24 to enable interlocking the trays 96 with the superjacent trays or box and subjacent trays, as described above with respect to FIG. 1. At the front corners of the tray 96, crease lines 105, 107, and 108 define triangular areas 110 of the floor 98 which, when the side walls 104 and 106 along crease lines 118 are folded upward will be reversely folded to allow single hook tabs 112 of the side walls 104 and 106 to be inserted into slots 114 of the front wall 100. When this is done, the triangular areas 110 serve as resilient levers to urge the single hook tabs 112 upward to ensure locking relation of the single hook tabs 112 with the slots 114.

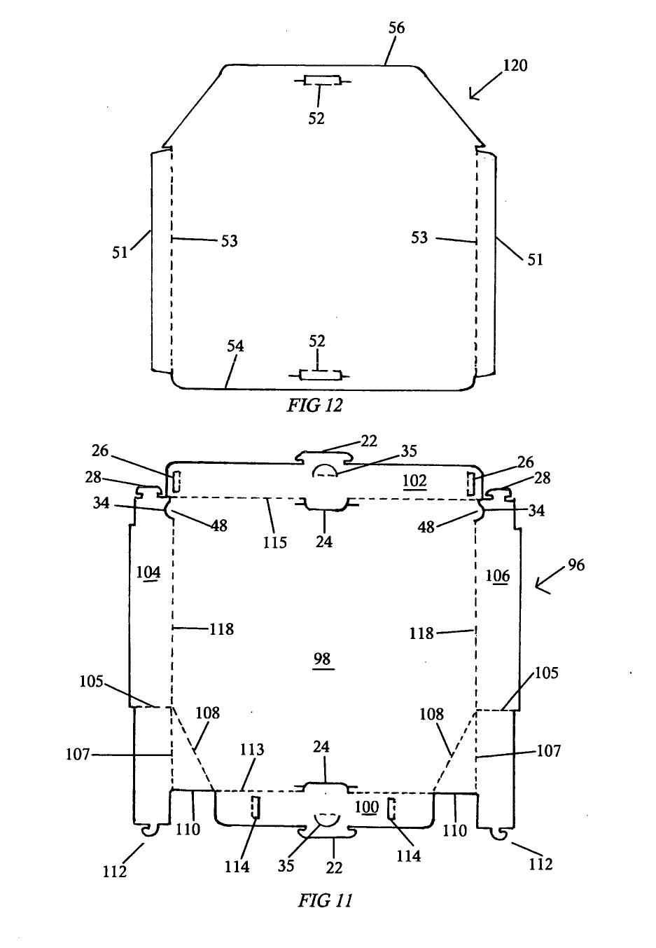

FIG. 12 shows a lid indicated generally at 120 for the use with a tray 96 of FIG. 11. As shown the lid 120 has flaps 51 which are folded along crease lines 53 Flaps 51 are inserted into tray 96, slits slots 52 adjacent the front edge 56 and rear edge 54 which serve to receive vertical interlocking tongues 22 of the tray 96 releasably interlock and secure the lid 120 to the tray 96. If a plurality of trays 96 are stacked the lid 120 need only be provided for the upper most tray 96 since the floors 98 of the other trays of the stack will serve as a lid for the subjacent rays 96.

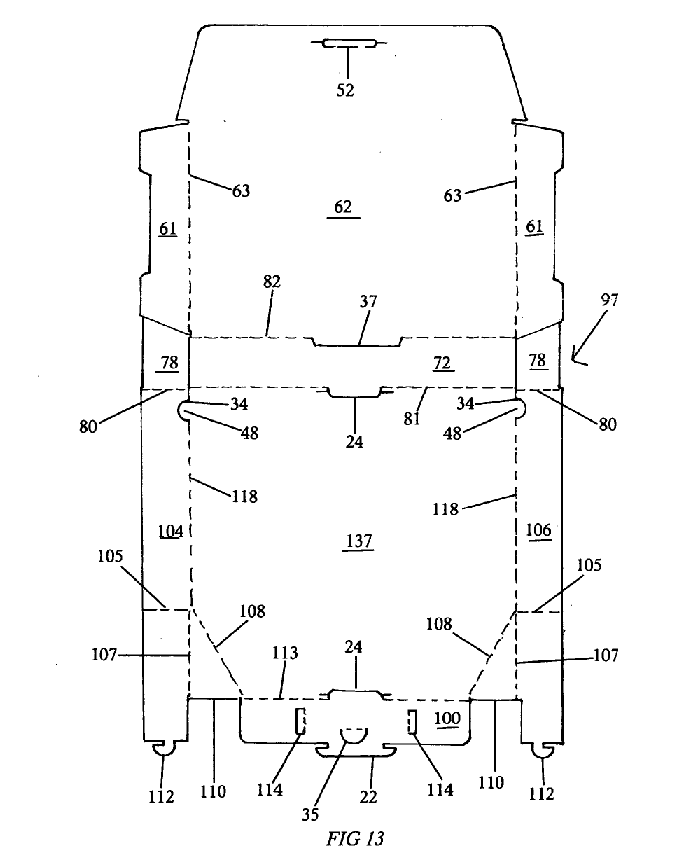

FIG. 13 shows an alternative form of the pizza delivery tray of FIG. 11 indicating generally at 97 having an attached lid 62. As shown the box 97 has a floor 137 of front wall 100 side wall 104 and 106 and a rear wall 72. The side walls 104 and 106 along crease lines 118 are connected to front wall 100 along crease line 113 and rear wall 72 along crease line 81 by single hook tabs 112 and slots 114 connections, similar to those connecting the front and side walls of FIG. 11 and similar numbers have been used to identify the respective components thereof. Also, front wall 100 carries vertical interlocking tongue 22 and tabs 24 on front wall 100 and rear wall 72 to enable interlocking the box 97 with subjacent trays of FIG. 11. At the front corners of box 97 crease lines 105, 107, and 108 define triangular areas 110 of the floor 137 which, when the side walls 104 and 106 along crease lines 118 are folded up will be reversely folded to allow single hook tabs 112 of the side walls 104 and 106 to be inserted into slots 114 of the front wall 100. When this is done the triangular areas 110 serve as resilient levers to urge the single hook tabs 112 upward to ensure locking relation of the single hook tabs 112 with the slots 114. The lid 62 is attached to the rear wall 72 and is folded upward along crease line 81. Flaps 78 along crease line 80 are folded inward and inserted within the rearer wall 72 to form the rear corners of the box 97. When the box 97 is assembled, side flaps 61 are folded inward along crease lines 63. The lid 62 is folded along crease line 82 to overlie the floor 137. The lid 62 is formed with slits slots 52 which receives vertical interlocking tongue 22 of the front wall 100 to secure the lid 62 to the box 97.

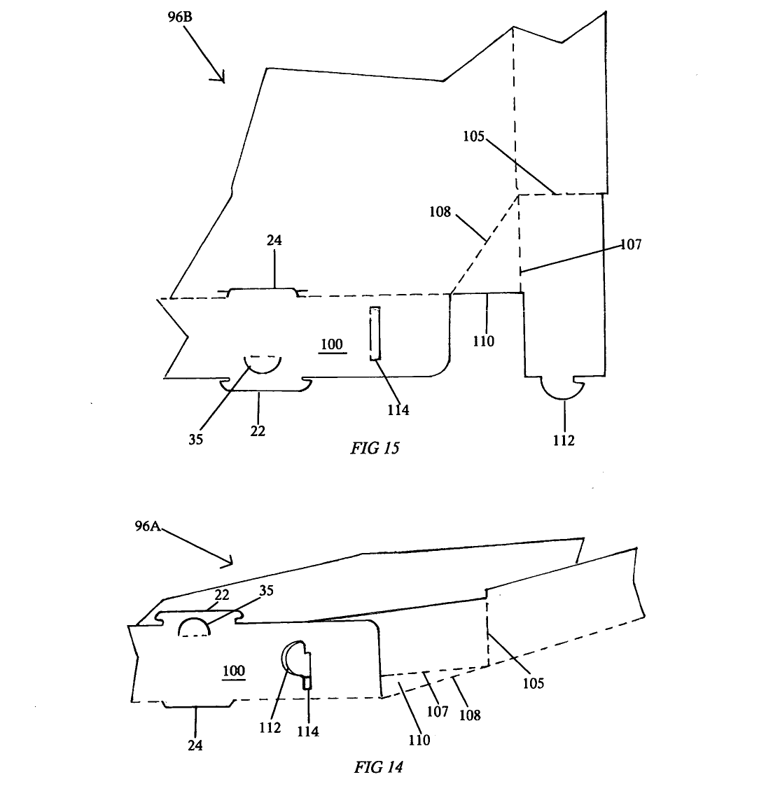

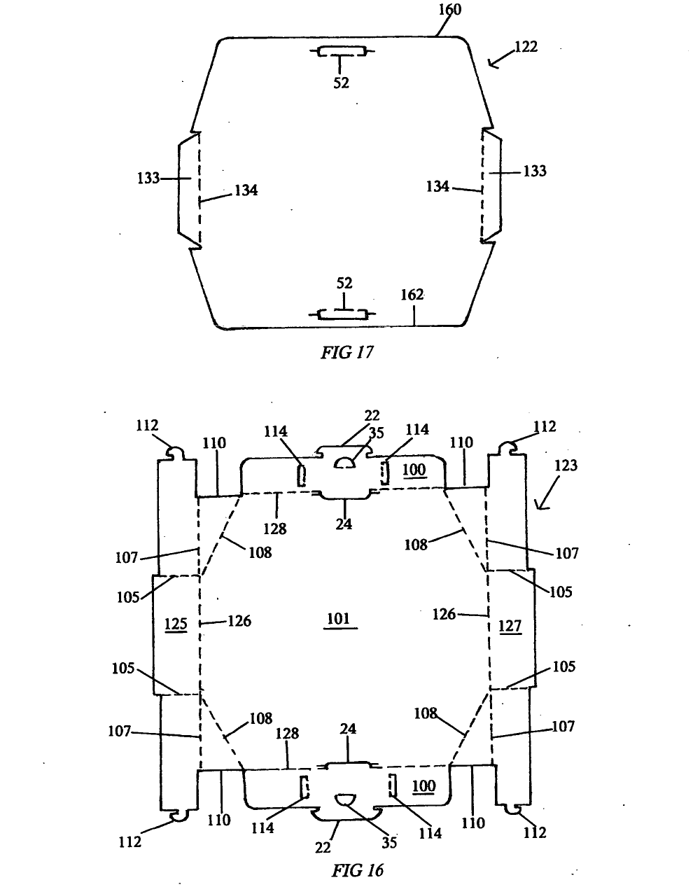

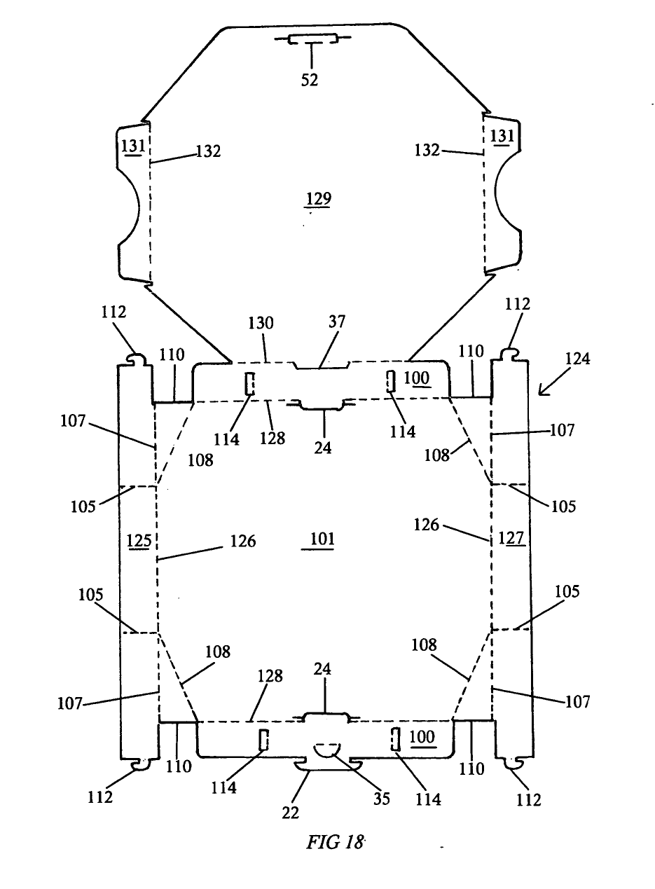

FIG. 14 is an enlarged perspective view generally at 96A, illustrating an assembled corner section of the single hook tab connection of FIG. 11 front corner sections, FIG. 13 front corner sections, FIG. 16 and FIG. 18 front and back corner sections. Component numbers and method of assembly is described in detail in FIG. 11.

FIG. 15 is an enlarged perspective view generally at 96B, illustrating an unassembled corner section of the single hook tab connection of FIG. 11 front corner sections, FIG. 13 front corner sections, FIG. 16 and FIG. 18 front and back corner sections. Component numbers and method of assembly is described in detail in FIG. 11.

FIG. 16 is a plane view of a fourth unfolded pizza delivery tray embodying the present invention generally at 123 having floor 101, front and rear walls 100 along crease lines 128 and side walls 125 and 127. The side walls 125 and 127 are connected to the front and rear walls 100 by single hook tabs 112 and slots 114; connections similar to those connecting the front and side walls of FIG. 11 and similar numbers have been used to identify the respective components thereof. Also the front and rear walls 100 carry vertical interlocking tongues 22 and tabs 24 to enable interlocking the tray 123 with the superjacent trays and box and subjacent trays as described with respect to FIG. 11. At the front and rear corners of tray 123 crease lines 105, 107 and 108 define triangular areas 110 of floor 101 which, when the sidewalls 125 and 127 along crease lines 126 are folded upward will be reversely folded to allow single hook tabs 112 of side walls 125 and 127 to be inserted into slots 114 of the front and rear walls 100. When this is done, the triangular areas 110 serve as resilient levers to urge the single hooked tabs 112 upward to insure locking relation of the single hooked tabs 112 with slots 114.

FIG. 17 shows a lid indicated generally at 122 for the use with the tray 123 of FIG. 16. As shown the lid 122 has flaps 133 which are folded along crease lines 134. Flaps 133 are inserted into tray 123 slits slots 52 adjacent the front edge 160 and rear edge 162 which serve to receive vertical interlocking tongues 22 of tray 123 to releasably interlock and secure the lid 122 to the tray 123. If a plurality of trays 123 are stacked the lid 122 need only be provided for the uppermost tray 123 since the floor 101 of the other trays of the stack will serve as a lid for the subjacent trays 96.

FIG. 18 shows an alternative form of the pizza delivery tray of 16 indicated generally at 124 having ana attached lid. As shown the box 124 has a floor 101, front and rear walls 100 along crease lines 128 and side walls 125 ands 127. The side walls 125 and 127 are connected to the front and rear walls 100 by single hook tabs 112 and slots 114. Connections similar to those connecting the front and side walls of FIG. 16 and similar numbers have been used to identify the respective components thereof. Also the front and rear walls 100 carry vertical interlocking tongues 22 and tabs 24 to enable interlocking the tray 123 with the subjacent trays as described above with respect to FIG. 16. At the front and rear corners of box 124 crease lines 105, 107, and 108 define triangular areas 110 of the floor 101 which, when the side walls 125 and 127 along crease lines 126 are folded upward will be reversely folded to allow single hook tabs 112 of the side walls 125 and 127 to be inserted into slots 114 of the front and rear walls 100. When this is done the triangular areas 110 serve as resilient levers to urge the single hook tabs 112 upward to ensure locking relation of the single hook tabs 112 with slots 114. The lid 129 is attached to the rear wall along crease line 130 when the box 124 is assembled side flaps 131 are folded inward along crease lines 132, the lid 129 is folded along crease line 130 to overlie the floor 101. The lid 129 is formed with slits slot 52 which receives vertical interlocking tongue 22 to the front wall 100 to secure the lid 129 to the box 124.

In addition, numerous other variations and modifications can be made without departing from the spirit of the present invention. Therefore, it should be clearly understood that the forms of the present invention described above and shown in the figures of the accompanying drawing are illustrateive only and are not intended to limit the scope of the present invention.

1. A pizza delivery box comprising:
a floor, two end walls and two side walls,
tab-and slot-connectors coupling one of said end walls with one of said side walls, and
means resiliently urging said tab-and-slot connectors into locking relation.

2. The pizza delivery box of claim 1 wherein:
said means is a cut extending inwardly from the edge of one of said side walls adjacent said one of said end walls.

3. The pizza delivery box of claim 1 wherein:
said means is a triangular portion of said floor adjacent the corner between said one of said side walls and said one of said end walls.

4. The pizza delivery box of claim 3 wherein:
said triangular portion is reversely folded when said side wall is folded upward to assemble said box.

5. The pizza delivery box of claim 1 further comprising:
one of said end walls being a rear wall, and
a lid attached to said rear wall.

6. The pizza delivery box of claim 1 further comprising:
said end walls each carrying tabs and slots for interlocking connection with superjacent or subjacent boxes.

7. The pizza delivery box of claim 6 further comprising:
a lid separate from said box and releasably attachable to said tabs.

8. The pizza delivery box of claim 1 further comprising:
at least one corner member extending diagonally between one of said end walls and an adjacent one of said side walls and formed with an upper portion and a lower portion,
said upper portion being foldable to overlie said lower portion and carrying a tab insertable into a slot in the floor adjacent said lower portion, and
end tabs carried by said end wall and said side wall insertable between said upper and lower portions of said corner member to form a corner for said box.

9. The pizza delivery box of claim 1 further comprising:
lid flaps attached to each of said side walls and foldable over said box and interlockable with each other to form a lid for said box.

10. The pizza delivery box of claim 1 wherein:
said tab-and-slot connectors comprise a tab on at least one of said side walls and a slot spaced from the end of an adjacent one of said end walls to cause a portion of said one of said side walls to extend diagonally to engage said slot.

11. The pizza delivery box of claim 2 wherein:
said cut has a portion forming a vent when said side wall is folded upward.

12. The pizza delivery box of claim 2 wherein:
said cut has a portion forming a flange when said side wall is folded upward to support said box on a subjacent box.
